(19) United States
(12) Patent Application Publication
(10) Pub. No.: US 2025/0033425 A1
(43) Pub. Date: Jan. 30, 2025

(54) METHOD AND APPARATUS FOR TRAILER HITCH ANGLE DETERMINATION

(71) Applicant: ZF CV Systems Global GmbH, Bern (CH)

(72) Inventor: Alec Vucsko, Lafayette, IN (US)

(21) Appl. No.: 18/770,424

(22) Filed: Jul. 11, 2024

Related U.S. Application Data
(60) Provisional application No. 63/516,172, filed on Jul. 28, 2023.

(51) Int. Cl. B60D 1/62

(52) U.S. Cl. CPC B60D 1/62

(57) ABSTRACT

A method determines a hitch angle of a trailer relative to a tractor via three distance sensors including a center distance sensor, a first outside distance sensor, and a second outside distance sensor. The method includes: measuring a distance between the tractor and the trailer via each of the three distance sensors; determining a first angle between the first outside distance sensor and the center distance sensor and a second angle between the second outside distance sensor and the center distance sensor based on the measured distances and the mounting distances between the three distance sensors; and, determining the hitch angle from the first angle and the second angle.

### CROSS-REFERENCE TO RELATED APPLICATIONS

This application claims priority of U.S. provisional application No. 63/516,172, filed Jul. 28, 2023, the entire content of which is incorporated herein by reference.

### TECHNICAL FIELD

The disclosure relates to determining the angle of a trailer to a tractor.

### BACKGROUND

DE 10 2012 006 206 A1 discloses a method for detecting an imminent collision between a towing vehicle by detecting a position of the trailer with respect to the towing vehicle and detecting an impending collision as a function of the detected position.

M. Bahramgiri, S. Nooshabadi, K. T. Olutomilayo and D. R. Fuhrmann, “Automotive Radar-Based Hitch Angle Tracking Technique for Trailer Backup Assistant Systems,” in IEEE Transactions on Intelligent Vehicles, vol. 8, no. 2, pp. 1922-1933 February 2023, doi: 10.1109/TIV.2022.3144896 discloses a solution using a kinematic model of the vehicle which requires knowledge of the trailer length before estimations can be made.

DE 10 2013 013 584 B4 discloses a trailing axle having power steering (hydraulic, pneumatic or electromechanical) and a control unit. The control unit detects an angle between the axle of a trailer and a tractor. A tachometer detects wheel speed of the axle of an assigned wheel. The control unit deactivates the power steering during failure of self calibration.

DE 101 54 612 A1 discloses a towing vehicle fitted with gap sensors at the rear that monitor the gap between vehicle and trailer. Depending on the angle (a) between the trailer and vehicle longitudinal axes, the left and right gaps between the two differ. An appropriate algorithm is used to assist the towing vehicle driver when reversing.

### SUMMARY

It is an object of the disclosure to provide a method and an apparatus for determining a trailer hitch angle between a tractor and a trailer towed by the tractor.

The aforementioned object can, for example, be achieved via a method of determining a hitch angle of a trailer relative to a tractor via three distance sensors including a center distance sensor, a first outside distance sensor, and a second outside distance sensor. The method includes: measuring a distance between the tractor and the trailer via each of the three distance sensors; determining a first angle between the first outside distance sensor and the center distance sensor and a second angle between the second outside distance sensor and the center distance sensor based on the measured distances and the mounting distances between the three distance sensors; and, determining the hitch angle from the first angle and the second angle.

According to an embodiment, the trailer can be a box trailer.

According to an embodiment, determining the hitch angle includes summing the first angle multiplied by a first coefficient and the second angle multiplied by a second coefficient.

According to an embodiment, a rate of change of a distance measurement via at least one of the first outside distance sensor and the second outside distance sensor to determine a direction of movement of the trailer is determined. According to a further embodiment, a 90 degree offset to the determined hitch angle when a high yaw state is detected is added. The high yaw state is detected when the determined hitch angle rises above 60 degrees. The high yaw state is terminated when the determined hitch angle drops below 30 degrees.

The aforementioned object can, for example, also be achieved via a system for determining a hitch angle of a trailer relative to a tractor defining a longitudinal center axis. The system includes: a plurality of distance sensors including a first outside distance sensor, a center distance sensor, and a second outside distance sensor arranged on the tractor so as to be directed toward the trailer when towed by the tractor; each of the plurality of sensors being configured to measure a corresponding distance to the trailer; a control unit configured to receive distance measurements of the first outside sensor, the second outside sensor, and the center distance sensor; the control unit being further configured to determine a first angle between the first outside distance sensor and the center distance sensor and a second angle between the second outside distance sensor and the center distance sensor based on the measured distances and the mounting distances between the three distance sensors; and, the control unit being further configured to determine the hitch angle from the first angle and the second angle.

According to an embodiment of the system, the trailer is a box trailer.

According to an embodiment of the system, the control unit is configured to determine the hitch angle by summing the first angle multiplied by a first coefficient and the second angle multiplied by a second coefficient.

According to a further embodiment of the system, the control unit is further configured to determine a rate of change of a distance measurement via at least one of the first outside distance sensor and the second outside distance sensor to determine a direction of movement of the trailer.

According to an embodiment of the system, the control unit is configured to add a 90 degree offset to the determined hitch angle when a high yaw state is detected.

According to an embodiment of the system, the control unit is configured to detect a high yaw state when the determined hitch angle rises above 60 degrees. The control unit is configured to terminate the high yaw state when the determined hitch angle drops below 30 degrees.

According to an embodiment of the system, the tractor is an autonomous vehicle.

The disclosure provides a cost-effective solution to trailer angle estimation without the need for the use of a camera or computer vision, which most existing solutions require. Additionally, according to the disclosure, no hardware is required to be attached to the trailer. Accordingly, the trailer can be switched out with another trailer and the hitch angle can still be determined without the new trailer needing any specialized hardware thereon.

According to the disclosure, the length of the trailer is not required as it would be for solutions utilizing a kinematic model or a camera for a computer vision system. The length of the box trailer is not relevant for embodiments according to the disclosure. Further, no physical connection of a sensor or other hardware to the trailer is required.

According to various embodiments, the trailer hitch determination is used for autonomous commercial vehicle driving. According to further various embodiments, the trailer hitch determination informs an operator of the hitch angle.

### BRIEF DESCRIPTION OF DRAWINGS

The invention will now be described with reference to the drawings wherein:

FIG. 1 shows a tractor and trailer at angle relative to each other;

FIG. 2 shows the tractor and trailer of FIG. 1 with a trailer hitch angle determination according to the disclosure;

FIG. 3 shows a tractor and a trailer in a high yaw state;

FIG. 4 shows a plot of angle coefficients for determining the angle of the trailer relative to the tractor; and,

FIG. 5 is a flowchart of a method for determining the angle of the tractor relative to the trailer.

### DETAILED DESCRIPTION

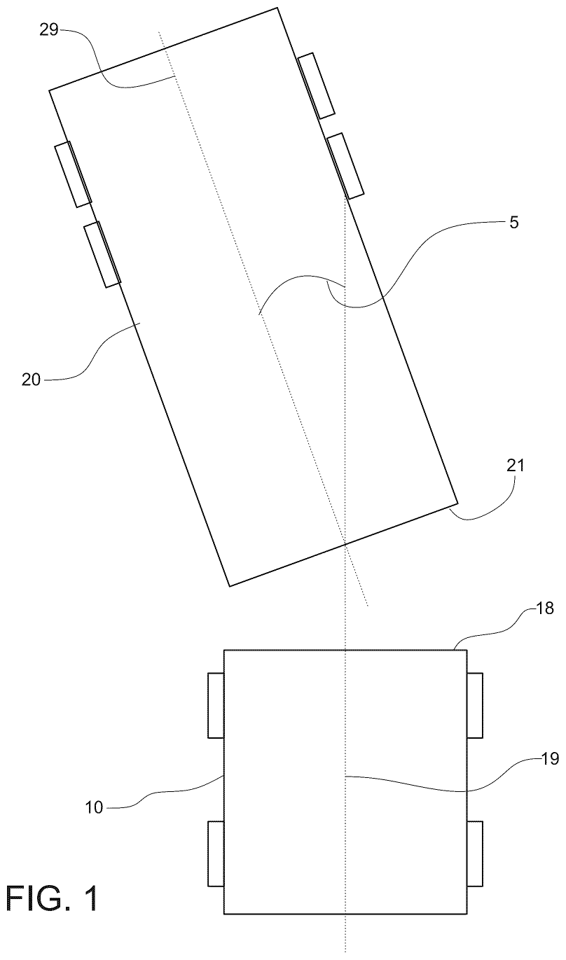

FIG. 1 shows a vehicle 1 which includes a tractor 10 towing a trailer 20. The trailer 20 will be at an angle to the tractor 10 when cornering or turning, often referred to as “hitch angle”. The hitch angle 5 corresponds to the angle formed between the longitudinal center axis 19 of the tractor 10 and of the longitudinal center axis 29 of the trailer 20.

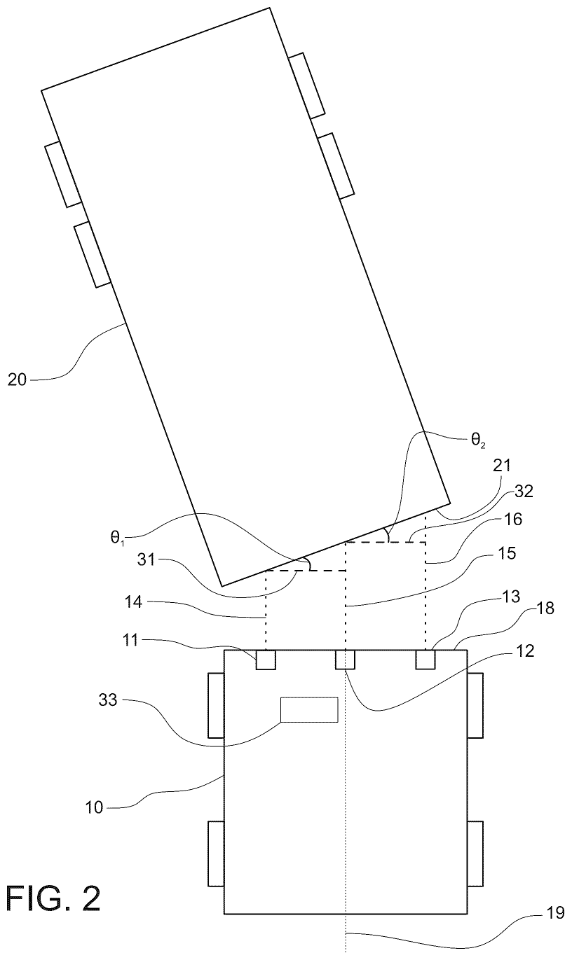

In the embodiment shown in FIG. 2, the tractor has three distance sensors 11, 12, 13 arranged at a back end 18 of the tractor 10. The three distance sensors include a center distance sensor 12 and two outside distance sensors 11, 13. The first outside distance sensor 11 and the second outside distance sensor 13 are arranged on opposite sides of the center distance sensor 12. The first outside distance sensor 11 can, for example, be a left distance sensor 11 and the second outside distance sensor 13 can, for example, be a right distance sensor 13. The distance sensors 11, 12, 13 can, for example, be sonar distance sensors, ultrasonic distance sensors, infrared distance sensors, laser distance sensors, light detection and ranging (LIDAR), time of flight distance sensors or the like.

Three distance sensors are used to detect the angle of the trailer 20 relative to the tractor 10, often referred to as the hitch angle 5. In the embodiment shown in FIG. 2, each of the three distance sensors 11, 12, 13 are aligned to measure the distance to the front end 21 of the trailer 20 in a straight line, parallel to the longitudinal center axis 19 of the tractor 10. Accordingly, the first outside distance sensor 11 measures a distance along line 14, the center distance sensor along line 15, and the second outside distance sensor along line 16.

The distance measurements of the distance sensors 11, 12, 13 are transmitted to a control unit 33. The control unit 33 determines the hitch angle 5 from the measurement values transmitted thereto from the distance sensors 11, 12, 13. The angles θ₁ and θ₂ are determined from the distance measurement values. The angles θ₁ and θ₂ can be calculated via the following formulas:

$$\begin{matrix}{θ}_{1} = arctan ( ( {d}_{15} - {d}_{14} ) / {d}_{31} ) ; \\ {θ}_{2} = arctan ( ( {d}_{16} - {d}_{15} ) / {d}_{32} ) ;\end{matrix}$$

wherein:
d14 is the distance measured by distance sensor 11 along measurement line 14;
d15 is the distance measured by distance sensor 12 along measurement line 15;
d16 is the distance measured by distance sensor 13 along measurement line 16;
d31 is the distance between distance sensors 11 and 12; and,
d32 is the distance between distance sensors 12 and 13.

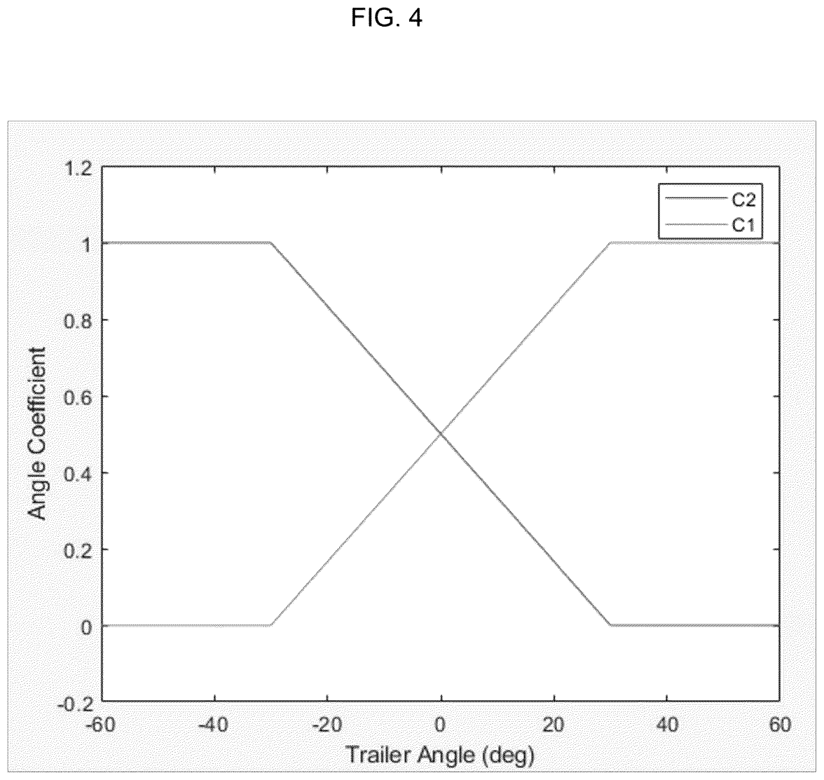

The two different angle measurements θ₁ and θ₂ are taken between the center distance sensor 12 and each of the outside distance sensors 11, 13. In particular, the first angle θ₁ is between line 31 and the front end of the trailer 21. The line 31 is perpendicular to the measurement line 14 and parallel to the back end 18 of tractor 10. The second angle θ₂ is between line 32 and the front end 21 of the trailer 20. The line 32 is perpendicular to measurement line 16 and parallel to the back end 18 of the tractor 10. These angles θ₁ and θ₂ are multiplied with a coefficient, for example as shown in FIG. 4, and added together to get the ultimate trailer hitch angle θ. From the angles θ₁ and θ₂ the hitch angle θ can be determined via the following formula wherein C₁ and C₂ are coefficients:

$$θ = {C}_{1} {θ}_{1} + {C}_{2} {θ}_{2}$$

The distance sensors can, for example, also be used to determine a rate of change in the distance. Determining the rate of change will provide the direction in which the trailer 20 is moving relative to the tractor 10.

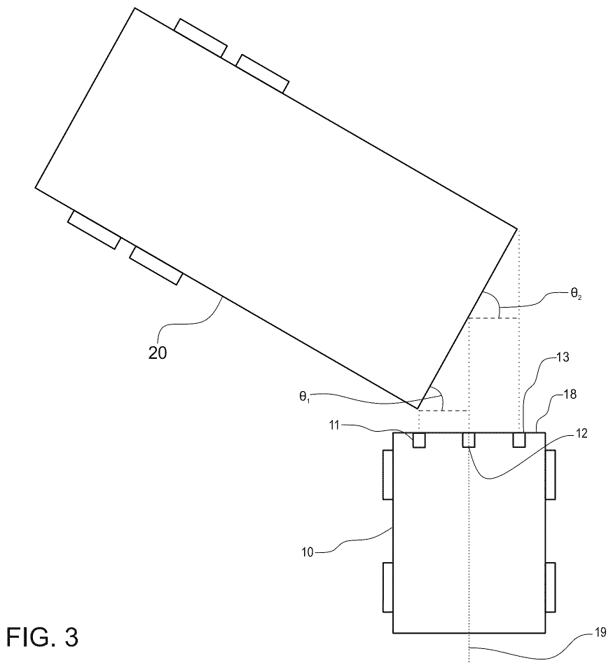

According to various embodiments, to handle high yaw cases, an offset of 90 degrees is added into the system to account for the sensor reading versus actual trailer angle. If the magnitude of the measured angle goes above 60 degrees as shown in FIG. 3, it is considered a high yaw case. It will not be considered a normal state again until the measured angle drops below 30 degrees.

According to an embodiment, the system is programed to handle high yaw states as follows:

```
If (High_Yaw == 1):
  Actual_Angle = 90 − Measured_Angle
  if Measured_Angle < 30 degrees:
  High_Yaw = 0
Else If (High_Yaw == 0):
  Actual_Angle = Measured_Angle
  if Measured_Angle > 60 degrees:
    High_Yaw = 1
  if Measured_Angle < −60 degrees:
    High_Yaw = −1
If (High_Yaw == −1):
  Actual_Angle = Measured_Angle − 90
  if Measured_Angle > −30 degrees:
    High_Yaw = 0
```

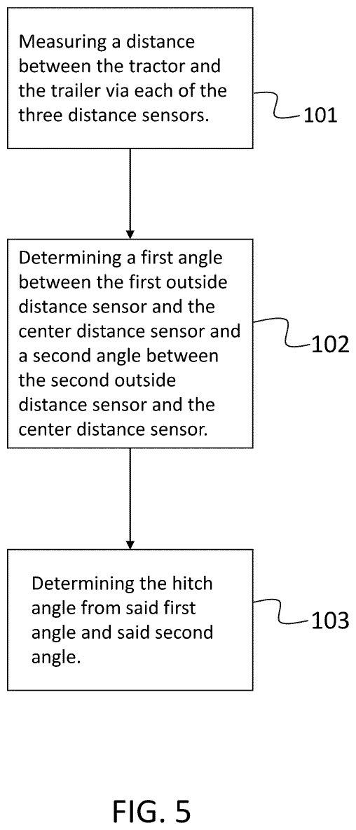

FIG. 5 is a flowchart showing an embodiment of a method according to the disclosure. In a first step 101, the distance between the tractor and the trailer is measured via each of the three distance sensors. In a second step 102, a first angle between the first outside distance sensor and the center distance sensor is determined and a second angle between the second outside distance sensor and the center distance sensor is also determined. In a third step 103, the hitch angle is determined from the first angle and the second angle.

It is understood that the foregoing description is that of the preferred embodiments of the invention and that various changes and modifications may be made thereto without departing from the spirit and scope of the invention as defined in the appended claims.

1. A method of determining a hitch angle of a trailer relative to a tractor via three distance sensors including a center distance sensor, a first outside distance sensor, and a second outside distance sensor, the method comprising:
measuring a distance between the tractor and the trailer via each of the three distance sensors;
determining a first angle between the first outside distance sensor and the center distance sensor and a second angle between the second outside distance sensor and the center distance sensor based on said measured distances and the mounting distances between the three distance sensors; and,
determining the hitch angle from said first angle and said second angle.

2. The method of claim 1, wherein the trailer is a box trailer.

3. The method of claim 1, wherein said determining the hitch angle includes summing said first angle multiplied by a first coefficient and said second angle multiplied by a second coefficient.

4. The method of claim 1 further comprising determining a rate of change of a distance measurement via at least one of the first outside distance sensor and the second outside distance sensor to determine a direction of movement of the trailer.

5. The method of claim 1 further comprising adding a 90 degree offset to the determined hitch angle when a high yaw state is detected.

6. The method of claim 5, wherein the high yaw state is detected when the determined hitch angle rises above 60 degrees.

7. The method of claim 6, wherein the high yaw state is terminated when the determined hitch angle drops below 30 degrees.

8. A system for determining a hitch angle of a trailer relative to a tractor defining a longitudinal center axis, the system comprising:
a plurality of distance sensors including a first outside distance sensor, a center distance sensor, and a second outside distance sensor arranged on said tractor so as to be directed toward the trailer when towed by the tractor;
each of said plurality of sensors being configured to measure a corresponding distance to the trailer;
a control unit configured to receive distance measurements of said first outside sensor, said second outside sensor, and said center distance sensor;
said control unit being further configured to determine a first angle between the first outside distance sensor and the center distance sensor and a second angle between said second outside distance sensor and said center distance sensor based on said measured distances and the mounting distances between the three distance sensors; and,
said control unit being further configured to determine the hitch angle from said first angle and said second angle.

9. The system of claim 8, wherein the trailer is a box trailer.

10. The system of claim 8, wherein said control unit is configured to determine the hitch angle by summing said first angle multiplied by a first coefficient and said second angle multiplied by a second coefficient.

11. The system of claim 8, wherein said control unit is further configured to determine a rate of change of a distance measurement via at least one of the first outside distance sensor and the second outside distance sensor to determine a direction of movement of the trailer.

12. The system of claim 8, wherein said control unit is configured to add a 90 degree offset to the determined hitch angle when a high yaw state is detected.

13. The system of claim 8, wherein said control unit is configured to detect a high yaw state when the determined hitch angle rises above 60 degrees.

14. The system of claim 13, wherein said control unit is configured to terminate the high yaw state when the determined hitch angle drops below 30 degrees.

15. The system of claim 8, wherein the tractor is an autonomous vehicle.
